(19) United States
(12) Patent Application Publication
(10) Pub. No.: US 2009/0216595 A1
(43) Pub. Date: Aug. 27, 2009

(54) SYSTEM, METHODS AND COMPUTER PRODUCTS TO MANAGE AN INDIVIDUAL MEETING WITH A TEAM

(75) Inventors: Beatrice Coulomb, Cagnes Sur Mer (FR); Olivier Foncarnier, La Colle sur Loup (FR); Gerard Mamigere, Drap (FR); Carole Truntschka, Saint Laurent Du Var (FR)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/035,681

(22) Filed: Feb. 22, 2008

(51) Int. Cl. G06Q 10/00

(52) U.S. Cl. 705/8

(57) ABSTRACT

Systems, methods and computer program products for managing an individual meeting within a team. Exemplary embodiments include a method for managing individual meetings for all attendees of a team, the method including storing individual times slots for each attendee, determining a maximum number of time slots, for each available attendee saving a time slot count, for each time slot saving an eligible attendee count, allocating slots in which one attendee has a free time, setting remaining time slots as busy, decrementing an eligible attendee count and determining if the maximum number of time slots has been reached.

This application claims priority to European Patent Application No. 07301711.3, filed 20 Dec. 2007, and all the benefits accruing therefrom under 35 U.S.C. §119, the contents of which in its entirety are herein incorporated by reference.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to data processing in general, and in particular to electronic calendar applications that are capable of scheduling meetings. Still more particularly, the present invention relates to a method for managing individual meetings for all person of a team.

2. Description of Background

Today many people are using electronic calendar applications in data processing systems to schedule meetings. An electronic calendar application allows a person to coordinate individual daily schedules and to schedule meetings among other people also having their own individual electronic calendar applications. In order to schedule a meeting, a user may input desired meeting information such as a requester and any attendee with whom the requester wishes to meet. The user may also input one or more proposed dates, times and durations for the intended meeting. The electronic calendar application then accesses the electronic calendars of the requester and all the potential attendees, and determines whether or not they will be available to attend the intended meeting on the proposed dates, times and durations. If a common proposed date, time and duration have been found for all potential attendees, the electronic calendar application of each potential attendee then places the meeting schedule on the potential attendee's individual electronic calendar.

Existing methods of exploding a meeting into several apply only to periodic meeting (i.e., to criteria based on date), all other information are in common, including invited people. Currently, to perform individual scheduling within a team a chairman must manually determine the meeting time based on the attendees' schedules and therefore the most consuming time solution.

### SUMMARY OF THE INVENTION

Exemplary embodiments include a method for managing individual meetings for all attendees of a team, the method including storing individual times slots for each attendee, determining a maximum number of time slots, for each available attendee saving a time slot count, for each time slot saving an eligible attendee count, allocating slots in which one attendee has a free time, setting remaining time slots as busy, decrementing an eligible attendee count and determining if the maximum number of time slots has been reached.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides systems, methods and computer program products that allow a chair to schedule meetings by obtaining an available time range from the chair calendar if the date and time range have not been specified, obtaining individual free times from the calendars of all of the attendees and finally allocating individual time slots.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for managing an individual meeting within a team;

FIG. 2 illustrates a block diagram of a system infrastructure in accordance with exemplary embodiments;

FIG. 3 illustrates a table in a first state for managing available time slots for multiple attendees in accordance with exemplary embodiments;

FIG. 4 illustrates a table in a second state for managing available time slots for multiple attendees in accordance with exemplary embodiments;

FIG. 5 illustrates a table in a third state for managing available time slots for multiple attendees in accordance with exemplary embodiments;

FIG. 6 illustrates a table in a final state for managing available time slots for multiple attendees in accordance with exemplary embodiments;

FIG. 7 illustrates a chart illustrating a resulting schedule for managing available time slots for multiple attendees in accordance with exemplary embodiments;

FIG. 8 illustrates a process flow for generating the tables of FIGS. 3-6 in accordance with exemplary embodiments; and

FIG. 9 illustrates a flow chart of a method for managing available time slots for multiple attendees in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, a meeting chair schedules separate meetings by specifying: a list of attendees; a meeting duration; a date and time range (optionally); a subject, location and the like. In exemplary embodiments, the process includes obtaining an available time range from the chair calendar if the date and time range have not been specified. Next, the process includes obtaining individual free times from the calendars of all of the attendees. Finally, the embodiments of the systems, methods and computer program products described herein allocate individual time slots.

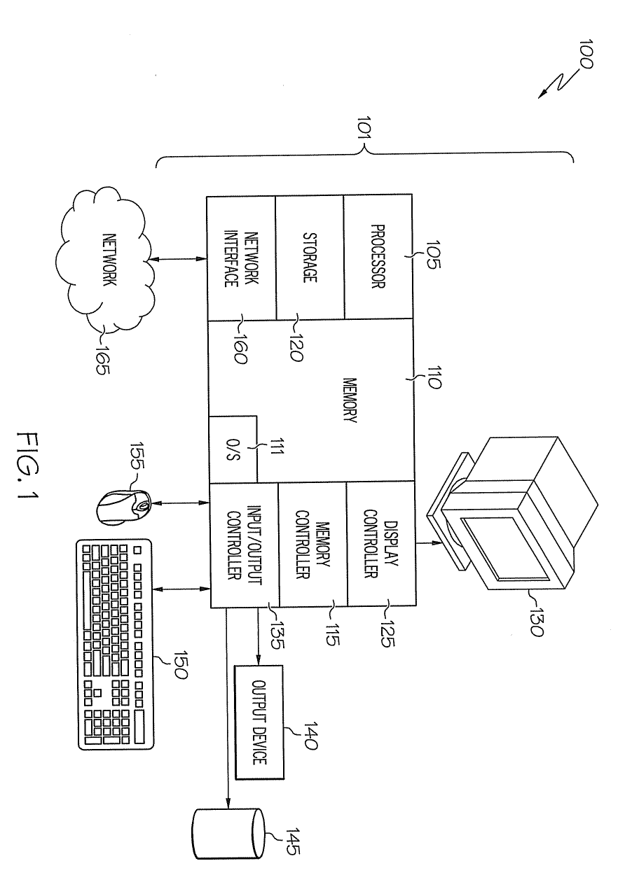

FIG. 1 illustrates an exemplary embodiment of a system 100 for managing an individual meeting within a team. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 101, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the meeting management methods described herein in accordance with exemplary embodiments and a suitable operating system (OS) 111. The operating system 111 essentially controls the execution of other computer programs, such the meeting management systems and methods described herein, and provides scheduling, input-output control, file and data management, memory management, and communication control and related services.

The meeting management methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the meeting management methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The meeting management methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The meeting management methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the meeting management methods are implemented in hardware, the meeting management methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

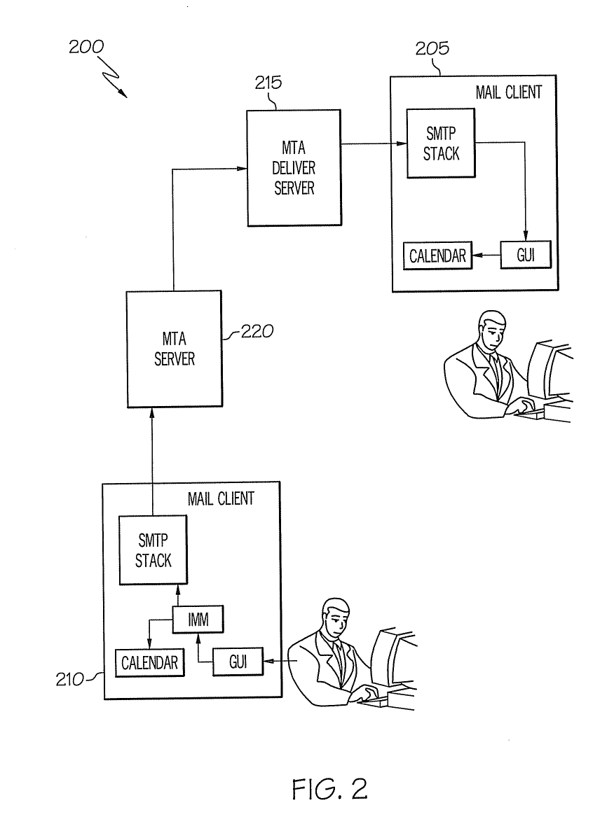

FIG. 2 illustrates a block diagram of a system infrastructure 200 in accordance with exemplary embodiments. The system infrastructure 200 includes two or more mail clients 205, 210 in communication with one another via one or more mail transfer agent (MTA) servers 215, 220. Each of the mail clients 205, 210 can include a SMTP stack, a calendar application and a graphical user interface (GUI). In exemplary embodiments, one of more of the mail clients 205, 210 can further includes an individual meeting manage (IMM) in communication with the respective calendar application and GUI. The IMM extends the function of the calendar application. The IMM helps in the management of: preparing scheduling (list of attendees, date and time, duration); obtaining individual calendars; allocating the meeting date/time to each person; sending invitations; managing responses and rescheduling impacted meetings, and the like.

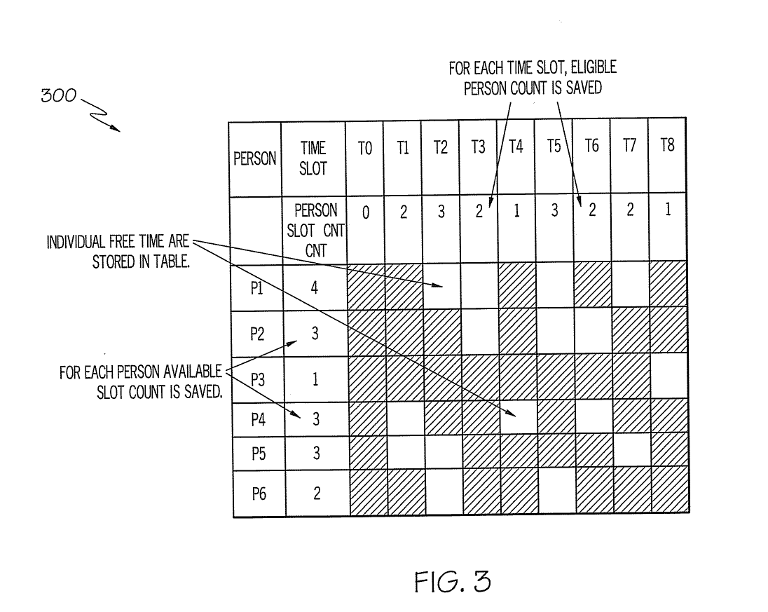

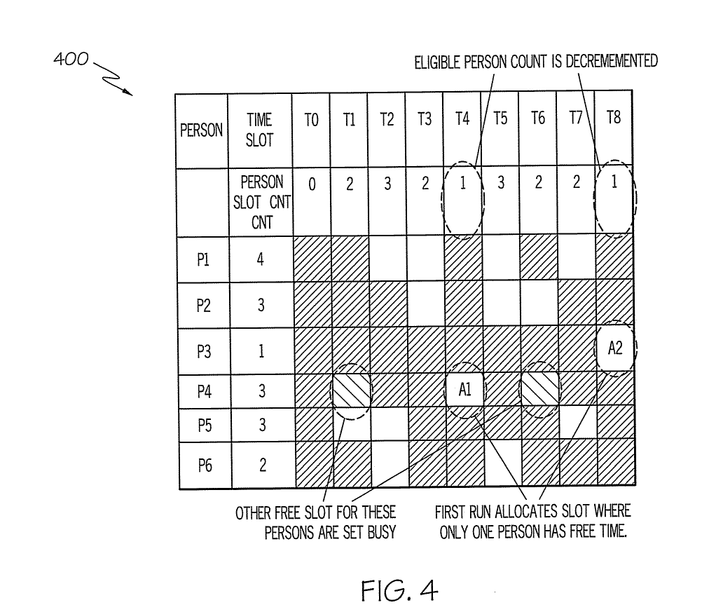

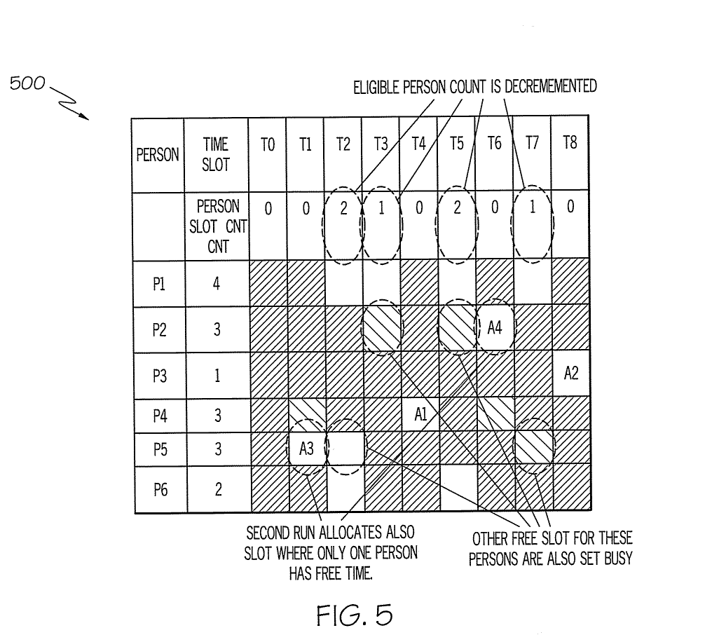

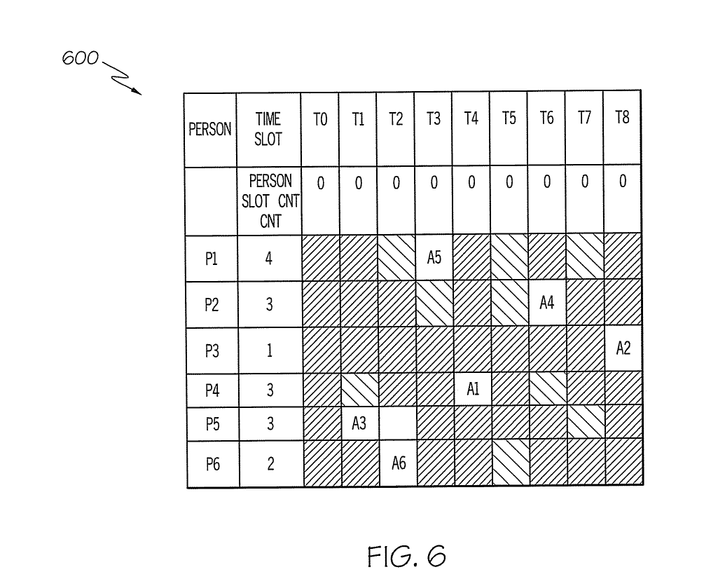

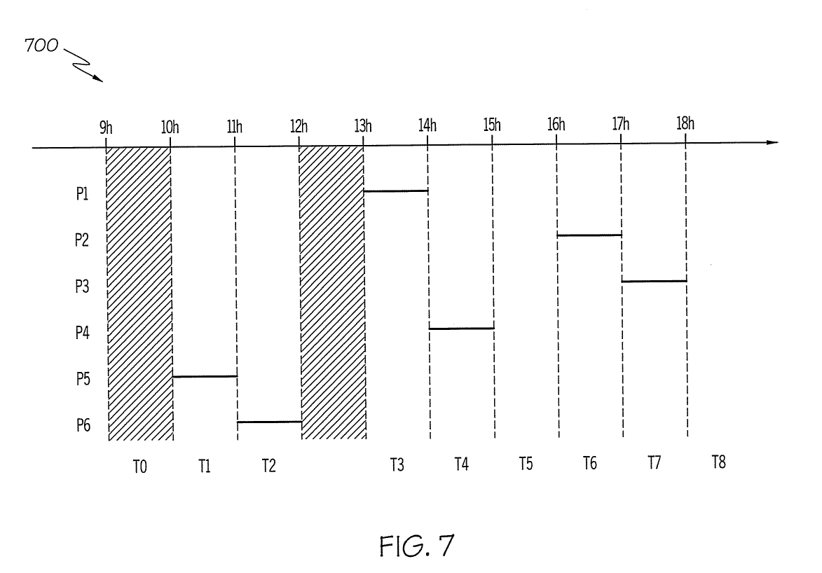

FIG. 3 illustrates a table 300 in a first state for managing available time slots for multiple attendees in accordance with exemplary embodiments. FIG. 4 illustrates a table 400 in a second state for managing available time slots for multiple attendees in accordance with exemplary embodiments. FIG. 5 illustrates a table 500 in a third state for managing available time slots for multiple attendees in accordance with exemplary embodiments. FIG. 6 illustrates a table 600 in a final state for managing available time slots for multiple attendees in accordance with exemplary embodiments. FIG. 7 illustrates a chart 700 illustrating a resulting schedule for managing available time slots for multiple attendees in accordance with exemplary embodiments.

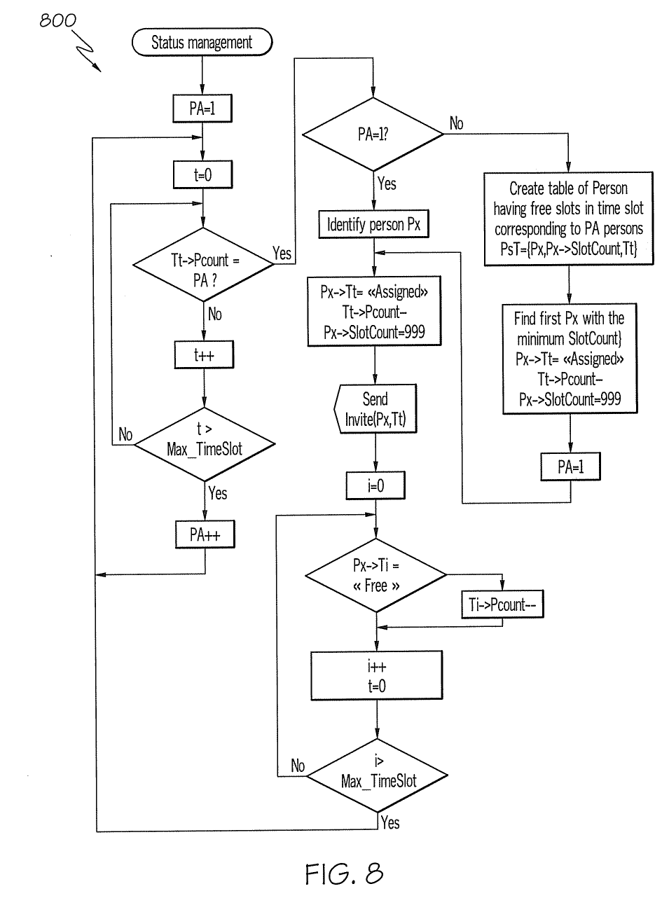

FIG. 8 illustrates a process flow 800 for generating the tables of FIGS. 3-6 in accordance with exemplary embodiments. The process flow 800 illustrates an algorithm for time slot allocation and invite generation in which PA Number of persons having time free in the slot, Tt is the time slot t (Eg T0,T1, . . . ), Px is the person Id (Eg P1,P2, . . . ), Pcount is the number persons having time free in this slot and SlotCount is the number of free slots associated to a person.

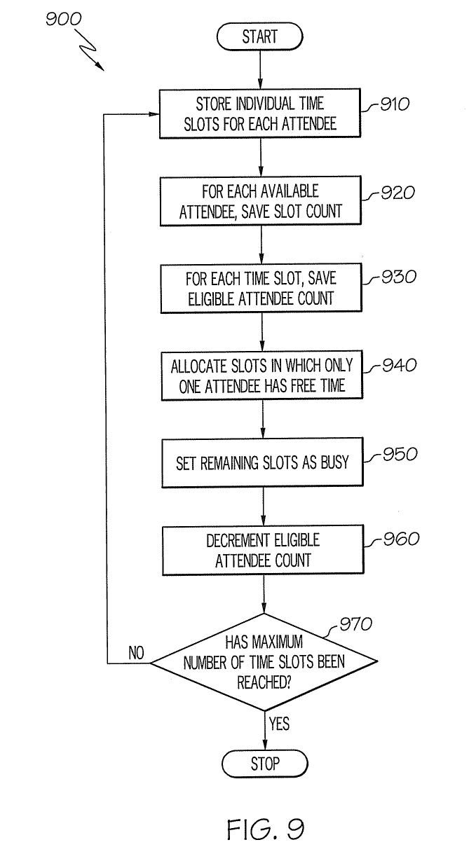

FIG. 9 illustrates a flow chart of a method 900 for managing available time slots for multiple attendees in accordance with exemplary embodiments. At block 910, the method 900 stores individual time slots for each attendee. At block 920, the method 900 saves a slot count for each available attendee. At block 930 the method 900 saves the eligible attendee count for each time slot. At block 940, the method 900 allocates slots in which one attendee has a free time. At block 950, the method 900 sets the remaining slots as busy. At block 960, the method 900 decrements the eligible attendee count. At block 970, the method 900 checks to see if a maximum number of times slots has been reached. If the maximum number of time slots has been reached, then the method 900 ends. If the maximum number of time slots has not been reached, then the method 900 continues at block 910. In exemplary embodiments, it is appreciated that even if the number of attendees count has been fully decremented at block 960, there may still be additional time slots available.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a computer system having a plurality of computers, each computer of the plurality of computers associated with a meeting attendee and having an electronic calendar application, a method for managing individual meetings for all attendees of a team, the method consisting of:
in a meeting chairman computer, storing individual times slots for each attendee;
determining a maximum number of time slots;
for each available attendee:
saving a time slot count;
for each time slot:
saving an eligible attendee count;
allocating slots in which one attendee has a free time;
setting remaining time slots as busy;
decrementing an eligible attendee count; and
determining if the maximum number of time slots has been reached.

2. The method as claimed in claim 1 further comprising generating a schedule based on the available time slots and available attendees.

3. The method as claimed in claim 2 further comprising setting a meeting based on the schedule.
